(19) United States
(12) Patent Application Publication
(10) Pub. No.: US 2007/0225438 A1
(43) Pub. Date: Sep. 27, 2007

(54) Resin Paste for Die Bonding

(76) Inventors: Yuji Hasegawa, Hitachi-shi (JP); Yasuhisa Odagawa, Tsukuba-shi (JP); Tooru Kikuchi, Hitachi-shi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/587,049

(22) PCT Filed: Feb. 15, 2005
(86) PCT No.: PCT/JP05/02229

§ 371 Date: Oct. 20, 2006

(30) Foreign Application Priority Data
Apr. 27, 2004 (JP) 2004-131359

(51) Int. Cl. C08L 79/08

(52) U.S. Cl. 524/879

(57) ABSTRACT

A resin paste for die bonding that can be supplied and applied easily by a printing method. The resin paste for die bonding of the present invention comprises: a polyimide resin (PI), which is obtained by reacting a tetracarboxylic dianhydride (A) comprising a tetracarboxylic dianhydride represented by the formula (I) shown below: 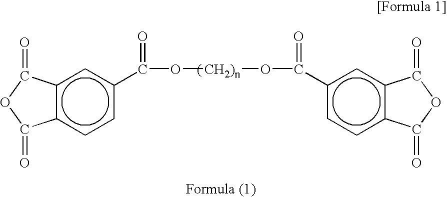
(wherein, n represents an integer from 2 to 20), with a diamine (B) comprising a siloxane-based diamine represented by the formula (II) shown below: 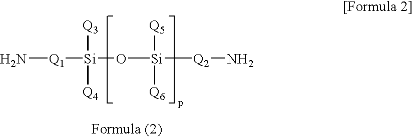
(wherein, Q₁ and Q₂ each represent, independently, an alkylene group of 1 to 5 carbon atoms or a phenylene group, Q₃, Q₄, Q₅ and Q₆ each represent, independently, an alkyl group of 1 to 5 carbon atoms, a phenyl group, or a phenoxy group, and p represents an integer from 1 to 50); a filler (F); and a printing solvent (S), wherein the resin paste has been adjusted to have a solid fraction from 20 to 70% by weight, a thixotropic index from 1.5 to 8.0, and a viscosity (25° C.) from 5 to 1,000 Pa·s.

### TECHNICAL FIELD

The present invention relates to a resin paste for a die bonding sheet that is used as a bonding material (a die bonding material) between a semiconductor element such as an IC or LSI, and a support member such as a lead frame or insulating support substrate.

### BACKGROUND ART

Conventional bonding materials for fixing an IC or LSI to a lead frame include Au—Si eutectic alloys, solders, or silver pastes.

Furthermore, the applicants of the present invention have previously proposed an adhesive film that uses a specific polyimide resin, and adhesive films for die bonding in which a conductive filler or an inorganic filler is added to a specific polyimide resin (see Japanese Patent Laid-Open No. H07-228697, Japanese Patent Laid-Open No. H06-145639, and Japanese Patent Laid-Open No. H06-264035).

Although the Au—Si eutectic alloys described above offer excellent heat resistance and moisture resistance, they also have high elastic modulus values, and are consequently prone to cracking when used with large chips. Furthermore, they also have the drawback of being expensive.

Although solders are cheap, they exhibit poor heat resistance, and also have high elastic modulus values similar to those of Au—Si eutectic alloys, making them unsuitable for use with large chips.

Silver pastes are cheap, exhibit a high level of moisture resistance, offer the lowest elastic modulus values amongst these conventional materials, and also have sufficient heat resistance to enable use with a 350° C. thermocompression wire bonder, and as a result, are currently the most commonly used die bonding materials. However, as the level of integration of IC and LSI chips increases, leading to increases in chip size, attempts to bond IC or LSI chips to lead frames using silver paste require the paste to be applied and spread across the entire chip surface, and this leads to significant difficulties.

The adhesive film for die bonding previously proposed by the applicants of the present invention enables bonding to be conducted at comparatively low temperatures and also has favorable adhesive strength upon heating, and can consequently be favorably employed for die bonding to 42-alloy lead frames. However, as modern packages have become smaller and more lightweight, the use of insulating support substrates has become more widespread, and in order to reduce production costs, methods that aim to supply the die bonding material using a printing method that offers favorable applicability to mass production are garnering much attention, whereas in order to supply and bond the above adhesive film to insulating support substrates in an efficient manner, the film must be cut (or punched out) to chip size prior to adhesion. Methods in which the adhesive film is cut out prior to bonding to a substrate require a bonding device to improve the production efficiency. Furthermore, methods in which the adhesive film is punched out and then bonded to a plurality of chips in a single batch operation tend to be prone to wastage of the adhesive film. Furthermore, because the majority of insulating support substrates comprise inner layer wiring formed within the substrate, the surface to which the adhesive film is bonded is very uneven, and this can lead to the generation of air gaps when the adhesive film is bonded, increasing the likelihood of a deterioration in reliability.

### DISCLOSURE OF INVENTION

An object of the present invention is to provide a resin paste for die bonding that can be supplied and applied easily by a printing method to substrates that require bonding to be conducted at comparatively low temperatures.

In order to achieve the above object, the present invention adopts the constitution described below. Namely, the present invention provides a resin paste for die bonding comprising: a polyimide resin (PI), which is obtained by reacting a tetracarboxylic dianhydride (A) comprising a tetracarboxylic dianhydride represented by a formula (I) shown below: 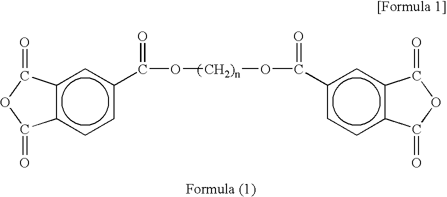
(wherein, n represents an integer from 2 to 20), with a diamine (B) comprising a siloxane-based diamine represented by a formula (II) shown below: 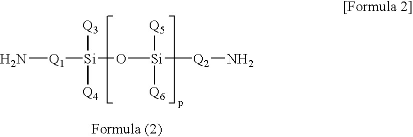
(wherein, Q₁ and Q₂ each represent, independently, an alkylene group of 1 to 5 carbon atoms or a phenylene group, Q₃, Q₄, Q₅ and Q₆ each represent, independently, an alkyl group of 1 to 5 carbon atoms, a phenyl group, or a phenoxy group, and p represents an integer from 1 to 50); a filler (F); and a printing solvent (S), wherein the resin paste is adjusted so as to have a solid fraction from 20 to 70% by weight, a thixotropic index from 1.5 to 8.0 (and preferably from 1.5 to 5.0), and a viscosity (25° C.) from 5 to 1,000 Pa·s (and preferably from 5 to 500 Pa·s).

The viscosity mentioned above refers to a value measured at 25° C. using an E-type rotational viscometer, with a rotation rate of 0.5 rpm. Furthermore, the thixotropic index is defined as the ratio between the viscosity value measured at 25° C. using an E-type rotational viscometer with a rotation rate of 1 rpm, and the viscosity value measured at a rotation rate of 10 rpm (thixotropic index=(viscosity at 1 rpm)/(viscosity at 10 rpm)).

If the aforementioned solid fraction is less than 20% by weight, then the shape variation arising from volumetric shrinkage following drying of the paste is undesirably large, whereas if the solid fraction exceeds 70% by weight, the fluidity of the paste deteriorates, causing a deterioration in the printing operability.

Furthermore, if the thixotropic index of the resin paste is less than 1.5, then the paste that is supplied and applied using a printing method may run or the like, causing a deterioration in the printed shape. If the thixotropic index exceeds 8.0, then the paste that is supplied and applied using a printing method is prone to developing chips or patchy coverage.

Furthermore, if the viscosity of the resin paste is either less than 5 Pa·s or exceeds 1,000 Pa·s, then the printing operability deteriorates. In those cases where a mesh or the like is stretched across the mask openings, such as the case of a screen mesh, then considering the ability of the paste to pass through the mesh, the viscosity of the resin paste is preferably within a range from 5 to 100 Pa·s, whereas in the case of a stencil or the like, the viscosity is preferably adjusted to a value within a range from 20 to 500 Pa·s. Furthermore, in those cases where large quantities of residual voids are observed within the paste following drying, adjusting the viscosity to no more than 150 Pa·s is effective.

Furthermore, the present invention also provides a resin paste for die bonding as described above, wherein the printing solvent (S) is a different solvent from the polyimide resin reaction solvent, and is capable of dissolving the polyimide resin (PI), is resistant to absorption of moisture from the air, has a boiling point of at least 100° C., and represents at least 50% by weight of the total quantity of solvent contained within the resin paste.

Furthermore, the present invention also provides a resin paste for die bonding as described above, wherein relative to 100 parts by weight of the polyimide resin (PI), the blend quantity of the filler (F) is from 5 to 1,000 parts by weight, and the blend quantity of the printing solvent (S) is from 50 to 1,000 parts by weight.

Furthermore, the present invention also provides a resin paste for die bonding as described above, which also comprises no more than 200 parts by weight of a thermosetting resin per 100 parts by weight of the polyimide resin (PI).

A resin paste for die bonding according to the present invention can be produced by separating the polyimide resin from a polyimide resin solution obtained by reacting a tetracarboxylic dianhydride (A) comprising a tetracarboxylic dianhydride represented by the formula (I) shown above with a diamine (B) comprising a siloxane-based diamine represented by the formula (II) shown above in a reaction solvent, dissolving the separated polyimide resin in a printing solvent so that the solid fraction within the final resin paste falls within a range from 20 to 70% by weight, the thixotropic index is from 1.5 to 8.0, and the viscosity falls within a range from 5 to 1,000 Pa·s, adding a thermosetting resin if required, and then adding and mixing in a filler.

This Application is based upon and claims the benefit of priority from prior Japanese Applications 2003-302798 filed on Aug. 27, 2003, and 2004-131359 filed on Apr. 27, 2004, the entire contents of which are incorporated herein by reference.

### BRIEF DESCRIPTION OF THE DRAWINGS

FIG. 1 is a schematic cross-sectional view of an apparatus for measuring peel adhesive strength.

### BEST MODE FOR CARRYING OUT THE INVENTION

As follows is a more detailed description of the present invention.

Examples of the tetracarboxylic dianhydride of the formula (I) that represents one of the production raw materials for the polyimide resin, when n is from 2 to 5, include 1,2-(ethylene)-bis(trimellitate)dianhydride, 1,3-(trimethylene)-bis(trimellitate) dianhydride, 1,4-(tetramethylene)bis(trimellitate)dianhydride and 1,5-(pentamethylene)-bis(trimellitate)dianhydride, and when n is from 6 to 20, include 1,6-hexamethylene)-bis(trimellitate)dianhydride, 1,7-(heptamethylene)-bis(trimellitate)dianhydride, 1,8-(octamethylene)-bis(trimellitate)dianhydride, 1,9-(nonamethylene)-bis(trimellitate)dianhydride, 1,10-(decamethylene)-bis(trimellitate)dianhydride, 1,1 2-(dodecamethylene)-bis(trimellitate)dianhydride, 1,1 6-(hexadecamethylene)-bis(trimellitate)dianhydride and 1,18-(octadecamethylene)-bis(trimellitate)dianhydride, and combinations of two or more of these compounds may also be used.

The tetracarboxylic dianhydrides described above can be synthesized from trimellitic anhydride monochloride and the corresponding diols.

Furthermore, in order to prevent any deterioration in the adhesive strength of the cured product, the quantity of the above tetracarboxylic dianhydride relative to the total quantity of tetracarboxylic dianhydrides is preferably at least 10 mol %, and even more preferably 15 mol % or greater.

Examples of other tetracarboxylic dianhydrides that can be used together with the tetracarboxylic dianhydride of the formula (I) include pyromellitic dianhydride, 3,3′,4,4′-diphenyltetracarboxylic dianhydride, 2,2′,3,3′-diphenyltetracarboxylic dianhydride, 2,2-bis(3,4-dicarboxyphenyl)propane dianhydride, 2,2-bis(2,3-dicarboxyphenyl)propane dianhydride, 1,1-bis(2,3-dicarboxyphenyl)ethane dianhydride, 1,1-bis(3,4-dicarboxyphenyl)ethane dianhydride, bis(2,3-dicarboxyphenyl)methane dianhydride, bis(3,4-dicarboxyphenyl)methane dianhydride, bis(3,4-dicarboxyphenyl)sulfone dianhydride, 3,4,9,10-perylenetetracarboxylic dianhydride, bis(3,4-dicarboxyphenyl)ether dianhydride, benzene-1,2,3,4-tetracarboxylic dianhydride, 3,3′,4,4′-benzophenonetetracarboxylic dianhydride, 2,2′,3,3′-benzophenonetetracarboxylic dianhydride, 2,3,3′,4′-benzophenonetetracarboxylic dianhydride, 1,2,5,6-naphthalenetetracarboxylic dianhydride, 2,3,6,7-naphthalenetetracarboxylic dianhydride, 1,2,4,5-naphthalenetetracarboxylic dianhydride, 1,4,5,8-naphthalenetetracarboxylic dianhydride, 4,4′-(4,4′-isopropylidenediphenoxy)bisphthalic dianhydride,

2,6-dichloronaphthalene-1,4,5,8-tetracarboxylic dianhydride, 2,7-dichloronaphthalene-1,4,5,8-tetracarboxylic dianhydride, 2,3,6,7-tetrachloronaphthalene-1,4,5,8-tetracarboxylic dianhydride, phenanthrene-1,8,9,1 0-tetracarboxylic dianhydride, pyrazine-2,3,5,6-tetracarboxylic dianhydride, thiophene-2,3,4,5-tetracarboxylic dianhydride, 2,3,3′,4′-biphenyltetracarboxylic dianhydride, 3,3′,4,4′-biphenyltetracarboxylic dianhydride, 2,2′,3,3′-biphenyltetracarboxylic dianhydride, bis(3,4-dicarboxyphenyl)dimethylsilane dianhydride, bis(3,4dicarboxyphenyl)methylphenylsilane dianhydride, bis(3,4-dicarboxyphenyl)diphenylsilane dianhydride, 1,4-bis(3,4-dicarboxyphenyldimethylsilyl)benzene dianhydride, 1,3-bis(3,4-dicarboxyphenyl)-1,1,3,3-tetramethyldicyclohexane dianhydride, p-phenylenebis(trimellitate)dianhydride,

ethylenetetracarboxylic dianhydride, 1,2,3,4-butanetetracarboxylic dianhydride, decahydronaphthalene-1,4,5,8-tetracarboxylic dianhydride, 4,8-dimethyl-1,2,3,5,6,7-hexahydronaphthalene-1,2,5,6-tetracarboxylic dianhydride, cyclopentane-1,2,3,4-tetracarboxylic dianhydride, pyrrolidine-2,3,4,5-tetracarboxylic dianhydride, 1,2,3,4-cyclobutanetetracarboxylic dianhydride, bis(exo-bicyclo[2,2,1]heptane-2,3-dicarboxylic dianhydride) sulfone, bicyclo-[2,2,2]octo-7-ene-2,3,5,6-tetracarboxylic dianhydride, 2,2-bis(3,4-dicarboxyphenyl)hexafluoropropane dianhydride, 2,2-bis[4-(3,4-dicarboxyphenoxy)phenyl]hexafluoropropane dianhydride, 4,4′-bis(3,4-dicarboxyphenoxy)diphenyl sulfide dianhydride, 1,4-bis(2-hydroxyhexafluoroisopropyl)benzene-bis(trimellitate)dianhydride, 1,3-bis(2-hydroxyhexafluoroisopropyl)benzene-bis(trimellitate)dianhydride, and tetahydrofuran-2,3,4,5-tetracarboxylic dianhydride, and mixtures of two or more compounds may also be used.

Examples of the siloxane-based diamine of the formula (II) that represents the other production raw material for the polyimide resin, when p is 1, include 1,1,3,3-tetramethyl-1,3-bis(4-aminophenyl)disiloxane, 1,1,3,3-tetraphenoxy-1,3-bis(4-aminoethyl)disiloxane, 1,1,3,3-tetraphenyl-1,3-bis(2-aminoethyl)disiloxane, 1,1,3,3-tetraphenyl-1,3-bis(3-aminopropyl)disiloxane, 1,1,3,3-tetramethyl-1,3-bis(2-aminoethyl)disiloxane, 1,1,3,3-tetramethyl-1,3-bis(3-aminopropyl)disiloxane, 1,1,3,3-etamethyl-1,3-bis(3-aminobutyl)disiloxane, and 1,3-dimethyl-1,3-dimethoxy-1,3-bis(4-aminobutyl)disiloxane,

when p is 2, include 1,1,3,3,5,5-hexamethyl-1,5-bis(4-aminophenyl)trisiloxane, 1,1,5,5-tetraphenyl-3,3-dimethyl-1,5-bis(3-aminopropyl)trisiloxane, 1,1,5,5-tetraphenyl-3,3-dimethoxy-1,5-bis(4-aminobutyl)trisiloxane, 1,1,5,5-tetraphenyl-3,3-dimethoxy-1,5-bis(5-aminopentyl)trisiloxane, 1,1,5,5-tetramethyl-3,3-dimethoxy-1,5-bis(2-aminoethyl)trisiloxane, 1,1,5,5-tetramethyl-3,3-dimethoxy-1,5-bis(4-aminobutyl)trisiloxane, 1,1,5,5-tetramethyl-3,3-dimethoxy-1,5-bis(5-aminopentyl)trisiloxane, 1,1,3,3,5,5-hexamethyl-1,5-bis(3-aminopropyl)trisiloxane, 1,1,3,3,5,5-hexaethyl-1,5-bis(3-aminopropyl)trisiloxane, and 1,1,3,3,5,5-hexapropyl-1,5-bis(3-aminopropyl)trisiloxane, and

when p is from 3 to 50, include the compounds shown below: 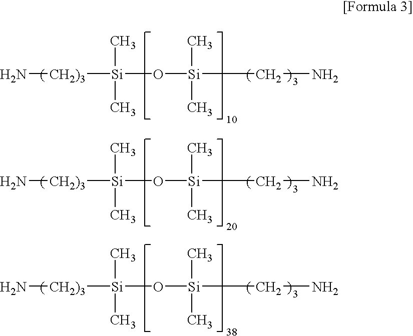
and combinations of two or more of these compounds may also be used.

In order to ensure satisfactory manifestation of low stress characteristics, low temperature adhesion (adhesion at a comparatively low temperature) or low moisture absorption, the quantity of these siloxane-based diamines relative to the total diamine content is preferably at least 3 mol %, even more preferably 5 mol % or greater, and most preferably 10 mol % or greater.

Other diamines can also be used in combination with the above siloxane-based diamine. Examples of other diamines that can be used in combination include aliphatic diamines such as 1,2-diaminoethane, 1,3-diaminopropane, 1,4-diaminobutane, 1,5-diaminopentane, 1,6-diaminohexane, 1,7-diaminoheptane, 1,8-diaminooctane, 1,9-diaminononane, 1,1 0-diaminodecane, 1,11-diaminoundecane and 1,1 2-diaminododecane, as well as aromatic diamines such as o-phenylenediamine, m-phenylenediamine, p-phenylenediamine, 3,3′-diaminodiphenyl ether, 3,4′-diaminodiphenyl ether, 4,4′-diaminodiphenyl ether, 3,3′-diaminodiphenylmethane, 3,4′-diaminodiphenylmethane, 4,4′-diaminodiphenylmethane, 3,3′-diaminodiphenyldifluoromethane, 3,4′-diaminodiphenyldifluoromethane, 4,4′-diaminodiphenyldifluoromethane, 3,3′-diaminodiphenyl sulfone, 3,4′-diaminodiphenyl sulfone, 4,4′-diaminodiphenyl sulfone, 3,3′-diaminodiphenyl sulfide, 3,4′-diaminodiphenyl sulfide, 4,4′-diaminodiphenyl sulfide,

3,3′-diaminodiphenyl ketone, 3,4′-diaminodiphenyl ketone, 4,4′-diaminodiphenyl ketone, 2,2-bis(3-aminophenyl)propane, 2,2′-(3,4′-diaminodiphenyl)propane, 2,2-bis(4-aminophenyl)propane, 2,2-bis(3-aminophenyl)hexafluoropropane, 2,2-(3,4′-diaminodiphenyl)hexafluoropropane, 2,2-bis(4-aminophenyl)hexafluoropropane, 1,3-bis(3-aminophenoxy)benzene, 1,4-bis(3-aminophenoxy)benzene, 1,4-bis(4-aminophenoxy)benzene, 3,3′-(1,4-phenylenebis(1-methylethylidene))bisaniline, 3,4′-(1,4-phenylenebis(1-methylethylidene))bisaniline, 4,4′-(1,4-phenylenebis(1-methylethylidene))bisaniline, 2,2-bis(4-(3-aminophenoxy)phenyl)propane, 2,2-bis(4-(4-aminophenoxy)phenyl)propane, 2,2-bis(4-(3-aminophenoxy)phenyl)hexafluoropropane, 2,2-bis(4-(4-aminophenoxy)phenyl)hexafluoropropane, bis(4-(3-aminophenoxy)phenyl)sulfide, bis(4-(4-aminophenoxy)phenyl)sulfide, bis(4-(3-aminophenoxy)phenyl)sulfone, and bis(4-(4-aminophenoxy)phenyl)sulfone.

Condensation of the tetracarboxylic dianhydride and the diamine is conducted within a reaction solvent (an organic solvent). In the reaction, the tetracarboxylic dianhydride and the diamine are preferably used in equimolar quantities or substantially equimolar quantities, although the order in which each component is added is arbitrary.

Examples of reaction solvents that can be used include dimethylacetamide, dimethylformamide, N-methyl-2-pyrrolidone (NMP), dimethyl sulfoxide, hexamethylphosphorylamide, m-cresol, and o-chlorophenol.

The reaction temperature is typically no higher than 80° C., and is preferably from 0 to 50° C. As the reaction progresses, the viscosity of the reaction liquid gradually increases. This indicates the generation of a polyamic acid that represents a precursor to the polyimide.

The polyimide can be obtained by a dehydration ring closure of the above reaction product (the polyamic acid). The dehydration ring closure can be conducted using either a method in which heat treatment is conducted at 120 to 250° C., or a chemical method. In the case of a method in which heat treatment is conducted at 120 to 250° C., the water generated by the dehydration reaction is removed from the system while the treatment proceeds. In this case, the water may be removed by azeotropic distillation using benzene, toluene, or xylene or the like. In this description, the term polyimide resin is a generic term that includes both polyimide and precursors thereto. Polyimide precursors include not only polyamic acid, but also materials in which a polyamic acid has undergone partial imidization.

In those cases where a chemical method is used to effect the dehydration ring closure, an anhydride such as acetic anhydride, propionic anhydride or benzoic anhydride, or a carbodiimide compound such as dicyclohexylcarbodiimide is used as a ring closure agent If required, a ring closure catalyst such as pyridine, isoquinoline, trimethylamine, aminopyridine or imidazole may also be used.

The ring closure agent and ring closure catalyst are preferably each used in a quantity within a range from 1 to 8 mols per 1 mol of the tetracarboxylic dianhydride. Furthermore, in order to improve the adhesive strength, silane coupling agents, titanium-based coupling agents, nonionic surfactants, fluorine-based surfactants and silicone-based additives may also be added to the polyimide resin.

Examples of the filler (F) used in the present invention include conductive (metal) fillers such as silver powder, gold powder and copper powder, and inorganic fillers such as silica, alumina, titania, glass, iron oxide, and ceramics.

Of these fillers, conductive (metal) fillers such as silver powder, gold powder and copper powder are added for the purposes of imparting conductivity, thermal conductivity, or thixotropic characteristics to the adhesive. Furthermore, inorganic fillers such as silica, alumina, titania, glass, iron oxide, and ceramics are added for the purposes of imparting low thermal expansion characteristics, a low moisture absorptivity, and thixotropic characteristics to the adhesive. These conductive fillers and inorganic fillers can also be used in mixtures of two or more materials. Furthermore, mixtures of conductive fillers and inorganic fillers may also be used, provided they do not impair the physical properties of the product.

The quantity of the filler is typically from 5 to 1,000 parts by weight, and preferably from 10 to 500 parts by weight, per 100 parts by weight of the polyimide resin. At quantities less than 5 parts by weight, imparting satisfactory thixotropic characteristics (a thixotropic index of at least 1.5) to the paste becomes difficult. Furthermore, if the quantity exceeds 1,000 parts by weight, then the adhesion deteriorates.

Mixing and kneading of the filler can be conducted using suitable combinations of typical stirring devices, and dispersion devices such as stone mills, three-roll mills and ball mills.

The printing solvent (S) used in the present invention is selected from amongst those solvents that are capable of dissolving the polyimide resin used and uniformly kneading or dispersing the filler. Furthermore, the selected solvent must be resistant to absorption of moisture from the air, and different from the polyimide resin reaction solvent. Moreover, considering the need to prevent volatilization of the solvent during printing, the selection of a solvent with a boiling point of at least 100° C. is preferred.

The reaction solvent used during synthesis of the polyimide resin is either removed in advance to prevent incorporation into the resin paste, or the quantity is reduced so that even if some incorporation occurs, the quantity does not exceed the weight of the printing solvent (S). In the present invention, the printing solvent (S) preferably represents at least 50% by weight of the total quantity of solvent incorporated within the resin paste.

Furthermore, the same comments also apply to the solvent within the thermosetting resin for those cases where a thermosetting resin such as those described below (epoxy resin+phenolic resin+curing accelerator and the like) is used. The solvent within the thermosetting resin is either removed in advance to prevent incorporation into the resin paste, or the quantity is reduced so that even if some incorporation occurs, the quantity does not exceed the weight of the printing solvent (S).

The reason for the above requirement is that the reaction solvent used in the synthesis of the polyimide resin and the thermosetting resin solvent are generally polar solvents, which are prone to absorption of moisture from the air, and if these solvents remain in the final paste, they absorb moisture from the air, which leads to separation of the polyimide resin and the solvent, making the resin paste prone to whitening.

Examples of the above printing solvent (S) include diethylene glycol dimethyl ether (also known as diglyme), triethylene glycol dimethyl ether (also known as triglyme), diethylene glycol diethyl ether, isophorone, carbitol acetate, 2-(2-butoxyethoxy)ethyl acetate, cyclohexanone and anisole, as well as solvents comprising mainly petroleum distillates, which are used as the solvents for printing inks. Mixtures of two or more of these solvents may also be used. Solvents which, compared with the N-methyl-2-pyrrolidone and dimethylacetamide typically used in the synthesis of polyimides, exhibit favorable resistance to absorption of moisture from the air and has good dissolution of polyimide resins can be favorably employed.

The quantity of the printing solvent (S) is typically from 50 to 1,000 parts by weight per 100 parts by weight of the polyimide resin.

Furthermore, in those cases where the generation of foam or voids is noticeable during printing of the resin paste, the addition of defoaming agents, foam breakers or foam suppressants to the printing solvent (S) is effective. The quantity of such addition is preferably within a range from 0.01 to 10% by weight of the solvent. If this quantity is less than 0.01% by weight, then the foam suppression effect does not manifest satisfactorily, whereas if the quantity exceeds 10% by weight, the adhesion and viscosity stability of the paste deteriorate.

Furthermore, in order to increase the shear adhesive strength upon heating, a thermosetting resin can also be blended into the resin paste of the present invention, in a quantity not exceeding 200 parts by weight (and preferably not exceeding 100 parts by weight) per 100 parts by weight of the (solid fraction of the) polyimide resin. If this blend quantity exceeds 200 parts by weight, then the storage stability of the resin paste deteriorates. A thermosetting resin refers to a resin which, on heating, cures and forms a three dimensional network structure. The use of either a resin paste containing a thermosetting resin or a resin paste containing no thermosetting resin can be determined in accordance with the intended application of the paste.

Preferred thermosetting resins include resins comprising an epoxy resin, a phenolic resin and a curing accelerator, and in such cases, the epoxy resin comprises at least 2 epoxy groups within each molecule, and from the viewpoints of curability and the properties of the cured product a phenol glycidyl ether-based epoxy resin is preferred, and specific examples of such resins include condensation products of bisphenol A, bisphenol AD, bisphenol S, bisphenol F or a halogenated bisphenol A with epichlorohydrin, glycidyl ethers of phenol novolak resins, glycidyl ethers of cresol novolak resins, and glycidyl ethers of bisphenol A novolak resins.

The quantity of the epoxy resin is typically less than 200 parts by weight, and preferably less than 100 parts by weight, per 100 parts by weight of the polyimide resin. If this quantity exceeds 200 parts by weight, then the storage stability of the paste tends to be prone to deterioration.

The phenolic resin used comprises at least two phenolic hydroxyl groups within the molecule, and suitable examples of such resins include phenol novolak resins, cresol novolak resins, bisphenol A novolak resins, poly-p-vinylphenol, and phenol aralkyl resins.

The quantity of the phenolic resin is typically within a range from 0 to 150 parts by weight, and preferably from 0 to 120 parts by weight, per 100 parts by weight of the epoxy resin. If this quantity exceeds 150 parts by weight, then the curability becomes inadequate.

The curing accelerator may be any material used for curing epoxy resins. Examples of such materials include imidazoles, dicyandiamides, dicarboxylic acid dihydrazides, triphenylphosphine, tetraphenylphosphonium tetraphenylborate, 2-ethyl-4-methylimidazole tetraphenylborate, and 1,8-diazabicyclo[5,4,0]undecene-7-tetraphenylborate. Combinations of two or more of these compounds may also be used.

The quantity of the curing accelerator is typically within a range from 0 to 50 parts by weight, and preferably from 0 to 20 parts by weight, per 100 parts by weight of the epoxy resin. If this quantity exceeds 50 parts by weight, then the storage stability of the paste tends to be prone to deterioration.

The thermosetting resin can use an imide compound containing at least two thermosetting imide groups within each molecule. Examples of such compounds include o-bismaleimidobenzene, m-bismaleimidobenzene, p-bismaleimidobenzene, 1,4-bis(p-maleimidocumyl)benzene, 1,4-bis(m-maleimidocumyl)benzene, as well as imide compounds represented by the formulas (III) through (V) shown below. 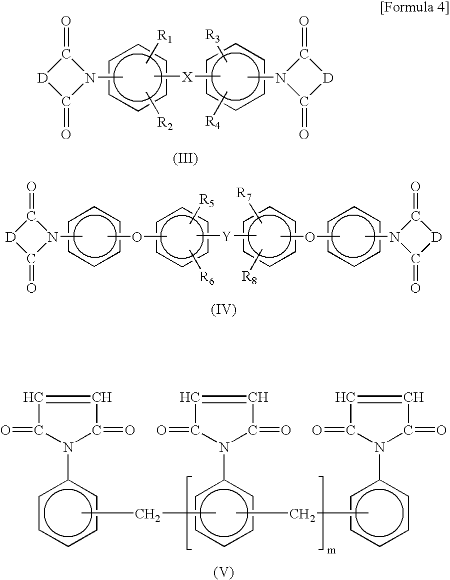
[wherein, X and Y represent O, CH₂, CF₂, SO₂, S, CO, C(CH₃)₂, or C(CF₃)₂, R₁, R₂, R₃, R₄, R₅, R6, R₇ and R₈ each represent, independently, a hydrogen atom, a lower alkyl group, a lower alkoxy group, or a fluorine, chlorine or bromine atom, D represents a dicarboxylic acid residue containing an ethylenic unsaturated double bond, and m represents an integer from 0 to 4]

The quantity of the imide compound is typically within a range from 0 to 200 parts by weight, and preferably from 0 to 100 parts by weight, per 100 parts by weight of the polyimide resin. If this quantity exceeds 200 parts by weight, then the storage stability of the paste tends to be prone to deterioration.

Specific examples of the imide compounds of the formula (III) include 4,4-bismaleimidodiphenyl ether, 4,4-bismaleimidodiphenylmethane, 4,4-bismaleimido-3,3′-dimethyl-diphenylmethane, 4,4-bismaleimidodiphenyl sulfone, 4,4-bismaleimidodiphenyl sulfide, 4,4-bismaleimidodiphenyl ketone, 2,2′-bis(4-maleimidophenyl)propane, 4,4-bismaleimidodiphenylfluoromethane, and 1,1,1,3,3,3,-hexafluoro-2,2-bis(4-maleimidophenyl)propane.

Specific examples of the imide compounds of the formula (IV) include bis[4-(4-maleimidophenoxy)phenyl]ether, bis[4-(4-maleimidophenoxy)phenyl]methane, bis[4-(4-maleimidophenoxy)phenyl]fluoromethane, bis[4-(4-maleimidophenoxy)phenyl]sulfone, bis[4-(3-maleimidophenoxy)phenyl]sulfone, bis[4-(4-maleimidophenoxy)phenyl]sulfide, bis[4-(4-maleimidophenoxy)phenyl]ketone, 2,2-bis[4-(4-maleimidophenoxy)phenyl]propane, and 1,1,1,3,3,3-hexafluoro-2,2-bis[4-(4-maleimidophenoxy)phenyl]propane.

In order to accelerate the curing of these imide compounds, a radical polymerization agent may be used. Examples of suitable radical polymerization agents include acetylcyclohexylsulfonyl peroxide, isobutyryl peroxide, benzoyl peroxide, octanoyl peroxide, acetyl peroxide, dicumyl peroxide, cumene hydroperoxide, and azobisisobutyronitrile. The quantity used of the radical polymerization agent is preferably within a range from approximately 0.01 to 1.0 parts by weight per 100 parts by weight of the imide compound.

The obtained resin paste for die bonding can be used to generate an adhesive-coated support substrate by using a printing method to supply and apply the resin paste of the present invention to a lead frame such as a 42-alloy lead frame or copper lead frame, a plastic film comprising a polyimide resin, epoxy resin or polyimide-based resin, a substrate comprising a glass woven base material into which a plastic such as a polyimide resin, epoxy resin or polyimide-based resin has been impregnated and then cured, or a support substrate (plate) formed from a ceramic such as alumina, and then drying the resin paste. Subsequently, a semiconductor element (chip) such as an IC or LSI is bonded to this adhesive-coated support substrate, and heat is then applied to bond the chip to the support substrate.

During preparation of the above adhesive-coated support substrate, a potting method can also be used instead of a printing method to apply the resin paste of the present invention, but this causes a deterioration in the efficiency of the application operation.

Furthermore, following supply and application of the resin paste using a printing method, the semiconductor element may also be bonded to the support substrate without drying the paste, and heat then applied to bond the chip to the support substrate, provided the package reliability is unaffected.

The present invention provides a resin paste for die bonding that can be supplied and applied easily by a printing method to substrates that require bonding to be conducted at comparatively low temperatures. Furthermore, a resin paste for die bonding according to the present invention has favorable heat resistance and whitening resistance, is easy to handle, and exhibits excellent properties of low stress and low temperature adhesion. Furthermore, because the adhesion to substrates is superior to that of film-based adhesives, the package reliability improves. The present invention can be favorably employed for die bonding to copper lead frames and insulating support substrates such as organic substrates, and can also be used with 42-alloy lead frames.

### EXAMPLES

As follows is a more detailed description of the present invention based on a series of polyimide resin synthesis examples and a series of examples.

### Synthesis of Polyimide Resin (1)

A 500 ml four-necked flask fitted with a thermometer, a stirrer, and a calcium chloride tube was charged with 54.0 g (0.06 mols) of Siliconediamine X22-161AS (manufactured by Shin-Etsu Chemical Co., Ltd., amine equivalence: 450) as a siloxane-based diamine of the formula (II), and 16.4 g (0.04 mols) of 2,2-bis(4-(4-aminophenoxy)phenyl)propane, and then 150 g of N-methyl-2-pyrrolidone was added and the mixture was stirred. Following dissolution of the diamine, the flask was cooled in an ice bath, and 10.4 g (0.02 mols) of decamethylene bistrimellitate dianhydride of the formula (I) and 24.8 g (0.08 mols) of bis(3,4-dicarboxyphenyl)ether dianhydride were added gradually in small portions. Following completion of this addition, the reaction was allowed to continue for 3 hours in the ice bath and then a further 4 hours at room temperature (25° C.), 25.5 g (0.25 mols) of acetic anhydride and 19.8 g (0.25 mols) of pyridine were then added, and the resulting mixture was stirred for 2 hours at room temperature. The reaction liquid was then poured into water, and the precipitated polymer was isolated by filtration and dried, yielding a polyimide resin PI₁.

Synthesis of Polyimide Resin (2)

A 500 ml four-necked flask fitted with a thermometer, a stirrer, and a calcium chloride tube was charged with 27.0 g (0.03 mols) of X22-161AS (amine equivalence: 450) as a siloxane-based diamine of the formula (II), and 28.7 g (0.07 mols) of 2,2-bis(4-(4-aminophenoxy)phenyl)propane, and then 200 g of N-methyl-2-pyrrolidone was added and the mixture was stirred. Following dissolution of the diamine, the flask was cooled in an ice bath, and 41.8 g (0.08 mols) of decamethylene bistrimellitate dianhydride of the formula (I) and 10.4 g (0.02 mols) of 4,4′-(4,4′-isopropylidenediphenoxy)bisphthalic dianhydride were added gradually in small portions. Following completion of this addition, the reaction was allowed to continue for 3 hours in the ice bath and then a further 5 hours at room temperature, 100 g of xylene was then added, the temperature was raised to 180° C. while nitrogen gas was blown into the system, and water and xylene were removed by azeotropic distillation. The reaction liquid was then poured into water, and the precipitated polymer was isolated by filtration and dried, yielding a polyimide resin PI₂.

Synthesis of Polyimide Resin (3, for comparison)

A 500 ml four-necked flask fitted with a thermometer, a stirrer, and a silica gel tube was charged with 41.0 g (0.1 mols) of 2,2-bis(4-(4-aminophenoxy)phenyl)propane and 150 g of N-methyl-2-pyrrolidone, and the mixture was stirred. Following dissolution of the diamine, the flask was cooled in an ice bath, and 52.1 g (0.1 mols) of 4,4′-(4,4′-isopropylidenediphenoxy)bisphthalic dianhydride was added gradually in small portions. The reaction was allowed to continue for 3 hours at room temperature, 100 g of xylene was then added, the temperature was raised to 180° C. while nitrogen gas was blown into the system, water and xylene were removed by azeotropic distillation, and the reaction liquid was then poured into water, and the precipitated polymer was isolated by filtration and dried, yielding a polyimide resin PI₃.

Preliminary Evaluation Tests for Obtained Polyimide Resins

<Test 1: Solubility of Polyimide Resin>

Each of the obtained polyimide resins PI₁ to PI₃ was tested for solubility in printing solvents (triglyme: TG, carbitol acetate: CA) and solubility in the reaction solvent used for the polyimide resin synthesis (N-methyl-2-pyrrolidone: NMP). The test involved adding 150 parts by weight of the solvent to 100 parts by weight of the polyimide resin and observing the level of solubility.

The results were as follows (O: soluble, x: insoluble fraction existed)

| | | | |
|---|---|---|---|
| Polyimide resin PI₁ | TG (∘) | CA (∘) | NMP (∘) |
| Polyimide resin PI₂ | TG (∘) | CA (∘) | NMP (∘) |
| Polyimide resin PI₃ | TG (x) | CA (x) | NMP (∘) |

Whereas the polyimide resins PI₁ and PI₂ dissolved in all three solvents TG, CA, and NMP, the comparative resin PI₃ dissolved only in NMP, and did not dissolve completely (an insoluble fraction existed) in either of the solvents TG or CA.

<Test 2: Whitening Resistance of Polymer Solution>

Each of the polyimide resins PI₁ to PI₃ was tested for whitening resistance (stability) following dissolution in the printing solvents and the reaction solvent. The test involved adding 150 parts by weight of TG, CA or NMP to 100 parts by weight of the polyimide resin, dissolving the resin, allowing the solution to stand for 1 hour in an atmosphere at a temperature of 23° C. and RH 50%, and then visually evaluating the degree of whitening of the solution.

The results were as follows (O: no whitening, x: whitening, -: insoluble fraction existed from outset, so test not performed)

| | | | |
|---|---|---|---|
| Polyimide resin PI₁ | TG (∘) | CA (∘) | NMP (x) |
| Polyimide resin PI₂ | TG (∘) | CA (∘) | NMP (x) |
| Polyimide resin PI₃ | TG (—) | CA (—) | NMP (x) |

The polyimide resins PI₁ and PI₂ suffered no whitening of the solution in either of the printing solvents (TG and CA). Solution whitening occurred within the reaction solvent NMP.

### Example 1

100 parts by weight of the powder of the polyimide resin PI₁ obtained in the synthesis (1) was weighed and placed inside a stone mill, 150 parts by weight of carbitol acetate (CA) was added as a printing solvent, and the resulting mixture was stirred thoroughly using a three-roll mill to completely dissolve the resin (polyimide resin solid fraction concentration: 40% by weight). Subsequently, a previously prepared solution comprising 10 parts by weight of an epoxy resin (ESCN-195) and 5.3 parts by weight of a phenolic resin (H-1) dissolved in carbitol acetate (23 parts by weight), and an NMP solution comprising 0.2 parts by weight of a curing accelerator (2P4MHZ) (the solid fraction concentration of these thermosetting resins was approximately 40% by weight) were added to the solution and mixed, 17 parts by weight of a finely powdered silica Aerosil was added, and the resulting mixture was stirred and kneaded for 1 hour,. yielding a resin paste for die bonding according to the present invention (resin paste No. 1).

### Examples 2 to 10, Comparative Examples 1 to 3

The nature and blend quantity of the polyimide resin, thermosetting resin, filler and/or solvent were altered, and preparation was conducted in the same manner as the example 1, yielding a series of resin pastes for die bonding according to the present invention (resin pastes No. 2 through No. 10) and a series of comparative resin pastes (No. 11 through 13). The composition of these resin pastes is shown in Table 1,

TABLE 1

| | Example 1 | Example 2 | Example 3 | Example 4 | Example 5 | Example 6 | Example 7 |
|---|---|---|---|---|---|---|---|
| Material | No. 1 | No. 2 | No. 3 | No. 4 | No. 5 | No. 6 | No. 7 |
| Polyimide resin | PI₁ | PI₁ | PI₁ | PI₂ | PI₂ | PI₂ | PI₁ |
| | 100 | 100 | 100 | 100 | 100 | 100 | 100 |
| Epoxy resin | ESCN-195 | YDCH-702 | N865 | YDCH-702 | N865 | ESCN-195 | ESCN-195 |
| | 10 | 50 | 100 | 20 | 15 | 20 | 10 |
| Phenolic resin | H-1 | H-1 | VH-4170 | VH-4170 | VH-4170 | H-1 | H-1 |
| | 5.3 | 24 | 57 | 10.7 | 8.5 | 10.6 | 5.3 |
| Curing | 2P4MHZ | TPPK | TPPK | TPPK | 2P4MHZ | 2P4MHZ | TPPK |
| accelerator | 0.2 | 0.5 | 1.0 | 0.2 | 0.3 | 0.4 | 0.2 |
| Filler | Aerosil | Aerosil | Aerosil | Aerosil | Aerosil | Aerosil | Aerosil |
| | 17 | 35 | 51 | 26 | 19 | 20 | 17 |
| | | | | | | BN | |
| | | | | | | 5 | |
| Solvent | CA | TG | TG | CA | TG | TG | TG |
| | 173 | 262 | 387 | 196 | 186 | 197 | 256 |

| | | | | Comparative | Comparative | Comparative |
|---|---|---|---|---|---|---|
| | Example 8 | Example 9 | Example 10 | example 1 | example 2 | example 3 |
| Material | No. 8 | No. 9 | No. 10 | No. 11 | No. 12 | No. 13 |
| Polyimide resin | PI1 | PI1 | PI2 | PI₃ | PI₃ | — |
| | 100 | 100 | 100 | 100 | 100 | |
| Epoxy resin | YDCH-702 | ESCN-195 | ESCN-195 | YDCH-702 | N865 | ESCN-195 |
| | 25 | 10 | 10 | 30 | 10 | 100 |
| Phenolic resin | VH-4170 | H-1 | H-1 | H-1 | VH-4170 | H-1 |
| | 13.4 | 5.3 | 5.3 | 14.5 | 5.7 | 53 |
| Curing | TPPK | 2P4MHZ | 2P4MHZ | TPPK | TPPK | 2P4MHZ |
| accelerator | 0.4 | 0.2 | 0.2 | 0.3 | 0.1 | 1.0 |
| Filler | Aerosil | Aerosil | Aerosil | Aerosil | Aerosil | Aerosil |
| | 15 | 8 | 10 | 22 | 17 | 31 |
| Solvent | CA | TG | TG | NMP | NMP | NMP |
| | 180 | 323 | 256 | 337 | 270 | 231 |

In Table 1, the various reference symbols refer to the materials described below. YDCH-702: a cresol novolak-based epoxy resin (epoxy equivalence: 220), manufactured by Tohto Kasei Co., Ltd.
N-865: a bisphenol novolak-based epoxy resin (epoxy equivalence: 208), manufactured by Dainippon Ink and Chemicals, Incorporated.
ESCN-195: a cresol novolak-based epoxy resin (epoxy equivalence: 200), manufactured by Nippon Kayaku Co., Ltd.
H-1: a phenol novolak resin (OH equivalence: 106), manufactured by Meiwa Plastic Industries, Ltd.
VH-4170: a bisphenol A novolak resin (OH equivalence: 118), manufactured by Dainippon Ink and Chemicals, Incorporated.
TPPK: tetraphenylphosphonium tetraphenylborate, manufactured by Tokyo Chemical Industry Co., Ltd.
2P4MHZ: Curezol, manufactured by Shikoku Corporation.
Aerosil: 380 (finely powdered silica), manufactured by Nippon Aerosil Co., Ltd.
BN: HP-P1H (boron nitride filler), manufactured by Mizushima Ferroalloy Co., Ltd.
TG: triglyme
CA: carbitol acetate
NMP: N-methyl-2-pyrrolidone

The viscosity and thixotropic index of each of the resin pastes following blending and mixing are shown in Table 2, The methods used for measuring the viscosity and thixotropic index are as described below.

Viscosity: The viscosity of the resin paste at 25° C. was measured with a E-type viscometer manufactured by Tokimec Inc., using a diameter of 19.4 mm and a 3° cone (0.5 rpm).

Thixotropic Index: measured using the above viscometer, and then calculated using the formula shown below.
Thixotropic index=(viscosity at 1 rpm)/(viscosity at 10 rpm)

For each of the obtained resin pastes, the peel adhesive strength was measured for chip bonding temperatures of 180° C. and 250° C. As is evident from Table 2, the peel adhesive strength for each of the resin pastes No. 1 through 10 at 180° C. was approximately equal to (slightly lower than) the adhesive strength at 250° C., indicating a powerful peel adhesive strength.

The method of measuring the peel adhesive strength is described below.

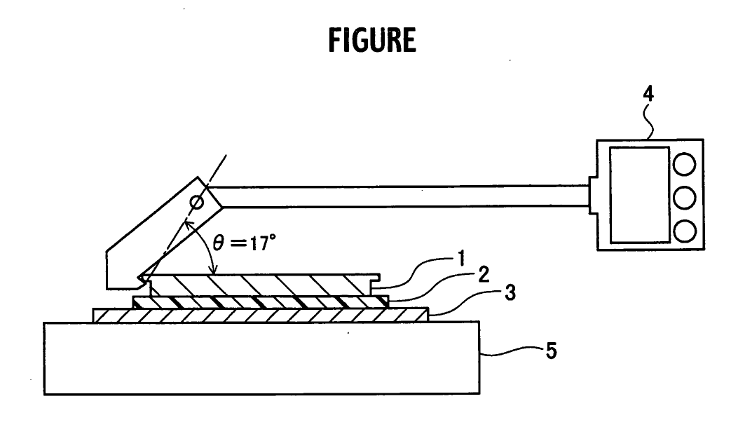

The resin paste was printed onto an organic substrate that had been coated with a solder resist PSR-4000AUS manufactured by Taiyo Ink Mfg. Co., Ltd., and following drying for 15 minutes at 60° C. and then 30 minutes at 100° C., a silicon chip of dimensions 5 mm×5 mm was pressed onto the resin paste for 5 seconds using a 1,000 g load, with the substrate sitting on a hot plate at either 180° C. or 250° C. Subsequently, following curing for one hour at 180° C., the apparatus shown in FIG. 1 was used to measure the peel strength upon heating at 250° C. for 20 seconds. In FIG. 1, numeral 1 represents the silicon ship, 2 represents the die bonding material, 3 represents the substrate, 4 represents a push-pull gauge, and 5 represents the hot plate.

The degree of chip warping when a silicon chip was bonded to a lead frame using each of the resin pastes obtained in No. 1 through 13 was also measured. The chip warping in those cases that used the resin pastes of No. 1 through 10 was less than half the chip warping observed in those cases that used the resin pastes of No. 11 through 13 (the comparative examples) (see Table 2).

The method of measuring the chip warping is described below.

The resin paste was printed onto an EF-TEC64T copper plate of thickness 150 μm manufactured by Furukawa Electric Co., Ltd., and was then dried for 15 minutes at 60° C. and then 30 minutes at 100° C., thus forming a die bonding material with a film thickness of 40 μm, and a silicon chip with dimensions of 13 mm×13 mm and a thickness of 400 μm was then placed on top of the die bonding material, a load of 1,000 g was applied, and the chip was subjected to thermocompression bonding for 5 seconds at 250° C. Following cooling to room temperature (25° C.), a surface roughness meter was used to scan the chip across 11 mm in a straight line, and the maximum height (μm) from the baseline was determined and used as the chip warping value.

TABLE 2

| | | | Thixo- | Peel adhesive | | Chip |
|---|---|---|---|---|---|---|
| | | Viscosity | tropic | strength (N/chip) | | warping |
| Resin paste | | (Pa · s) | index | 180° C. | 250° C. | (μm) |
| No. 1 | Example 1 | 170 | 3.5 | 19 | 24 | 15 |
| No. 2 | Example 2 | 220 | 4.5 | 22 | 26 | 18 |
| No. 3 | Example 3 | 230 | 4.8 | 18 | 24 | 20 |
| No. 4 | Example 4 | 230 | 5 | 18 | 22 | 18 |
| No. 5 | Example 5 | 150 | 3.2 | 22 | 30 | 17 |
| No. 6 | Example 6 | 150 | 3.5 | 16 | 20 | 18 |
| No. 7 | Example 7 | 80 | 3.5 | 20 | 21 | 15 |
| No. 8 | Example 8 | 450 | 4.0 | 19 | 18 | 16 |
| No. 9 | Example 9 | 10 | 1.5 | 23 | 25 | 12 |
| No. 10 | Example 10 | 20 | 1.8 | 24 | 26 | 13 |
| No. 11 | Comparative | 250 | 3.4 | 2 | 20 | 45 |
| | example 1 | | | | | |
| No. 12 | Comparative | 310 | 3.2 | 3 | 18 | 41 |
| | example 2 | | | | | |
| No. 13 | Comparative | 140 | 3.3 | 5 | 5 | 59 |
| | example 3 | | | | | |

A resin paste for die bonding according to the present invention has favorable heat resistance and whitening resistance, is easy to handle, and exhibits excellent properties of low stress and low temperature adhesion.

1. A resin paste for die bonding comprising: a polyimide resin (PI), which is obtained by reacting a tetracarboxylic dianhydride (A) comprising a tetracarboxylic dianhydride represented by a formula (I) shown below: 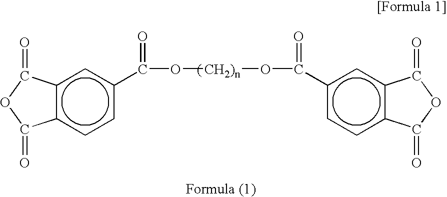
(wherein, n represents an integer from 2 to 20) with a diamine (B) comprising a siloxane-based diamine represented by a formula (II) shown below: 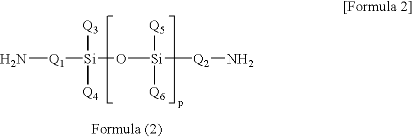
(wherein, Q₁ and Q₂ each represent, independently, an alkylene group of 1 to 5 carbon atoms or a phenylene group, Q₃, Q₄, Q₅ and Q₆ each represent, independently, an alkyl group of 1 to 5 carbon atoms, a phenyl group, or a phenoxy group, and p represents an integer from 1 to 50); a filler (F); and a printing solvent (S), wherein the resin paste has a solid fraction within a range from 20 to 70% by weight, a thixotropic index from 1.5 to 8.0, and a viscosity (25° C.) from 5 to 1,000 Pa·s.

2. The resin paste for die bonding according to claim 1, wherein the printing solvent (S) is a different solvent from a polyimide resin reaction solvent, and is capable of dissolving the polyimide resin (PI), is resistant to absorption of moisture from the air, has a boiling point of at least 100° C., and represents at least 50% by weight of a total quantity of solvent contained within the resin paste.

3. The resin paste for die bonding according to claim 1, wherein relative to 100 parts by weight of the polyimide resin (PI), a blend quantity of the filler (F) is from 5 to 1,000 parts by weight, and a blend quantity of the printing solvent (S) is from 50 to 1,000 parts by weight.

4. The resin paste for die bonding according to claim 3, further comprising no more than 200 parts by weight of a thermosetting resin per 100 parts by weight of the polyimide resin (PI).

5. The resin paste for die bonding according to claim 2, wherein relative to 100 parts by weight of the polyimide resin (PI), a blend quantity of the filler (F) is from 5 to 1,000 parts by weight, and a blend quantity of the printing solvent (S) is from 50 to 1,000 parts by weight.

6. The resin paste for die bonding according to claim 5, further comprising no more than 200 parts by weight of a thermosetting resin per 100 parts by weight of the polyimide resin (PI).
